(19) United States
(12) Patent Application Publication
(10) Pub. No.: US 2010/0175506 A1
(43) Pub. Date: Jul. 15, 2010

(54) TOUGHENED GRAPHITE ELECTRODES FOR ELECTRIC ARC FURNACES

(75) Inventors: Peter J. Pappano, Oak Ridge, TN (US); Cristian I. Contescu, Knoxville, TN (US)

Correspondence Address: Scully Scott Murphy & Presser PC, 400 Garden City Plaza, Suite 300, Garden City, NY, 11530, US

(73) Assignee: UT-BATTELLE, LLC, Oak Ridge, TN (US)

(21) Appl. No.: 12/353,372

(22) Filed: Jan. 14, 2009

(51) Int. Cl. C21C 5/52; C09K 3/00

(52) U.S. Cl. 75/10.66; 252/502; 75/10.65

(57) ABSTRACT

The present invention is directed to a method for producing a carbon fiber-pitch binder composition, the method comprising combining surface-modified carbon fibers with a molten pitch binder such that the surface-modified carbon fibers are substantially homogeneously dispersed throughout said molten pitch binder, wherein said surface-modified carbon fibers possess a surface that has been modified in a manner that increases the dispersability of the carbon fibers into said molten pitch binder. The invention is also directed to a method for producing a toughened graphite electrode and a method for processing metal in an electric arc furnace. The invention is also directed to carbon fiber-pitch binder compositions prepared by the inventive method in which carbon fibers are substantially homogeneously dispersed in the composition.

This invention was made with government support under Contract Number DE-AC05-00OR22725 between the United States Department of Energy and UT-Battelle, LLC. The U.S. Government has certain rights in this invention.

### FIELD OF THE INVENTION

The present invention relates to the manufacture of pitch-containing materials, and more particularly the manufacture of graphite electrodes, especially those suited for use in electric arc furnaces.

### BACKGROUND OF THE INVENTION

Graphite electrodes are used primarily in electric arc furnaces (EAF) to melt steel, titanium, and other metal scrap. The electrodes are consumed in the melting process. The graphite electrodes used for this purpose are typically cylindrical and can greatly vary in size. Graphite electrodes are typically manufactured by mixing petroleum coke particles with a pitch binder (typically coal-tar pitch), extruding the mix through a die, and subjecting the extruded mix to graphitizing conditions (e.g., temperatures of at least about 2500° C.).

Cracking or failure of the electrode prior to complete melting of the scrap metal results in the inoperability of the electrode, which in turn causes significant downtime and loss of productivity as the furnace needs to be turned off, the scrap steel removed, and the faulty electrode replaced. The fragility of current EAF electrodes and their potential for failure have necessitated the steel industry to sort the scrap that goes to the EAF such that only those pieces deemed unlikely to cause a failure are included whereas those deemed of high risk to cause a failure (i.e., of “Trougher stock”) are excluded. Typically, rougher stock samples of metal are the larger and more jagged pieces. The pre-sorting of metal samples being sent to the arc furnace is a time consuming and costly process. In addition, since the sorting process is generally highly susceptible to error in judgment, the sorting process also has a poor record in averting failure of electrodes.

In an attempt to reduce the failure rate of graphite electrodes, practitioners in the art have toughened the electrodes by adding carbon fibers to the electrode mix during electrode fabrication. Indeed, the subsequent carbon fiber-reinforced electrodes exhibit a significantly reduced rate of failure during EAF operations. However, a significant obstacle in the foregoing toughening method is that the carbon fibers are very expensive relative to the coke and pitch. The significant expense of the carbon fibers results in the increased cost of the electrode, and therefore, an increased cost of the process. Another problem in the carbon fiber toughening method is that the carbon fibers incorporated into the electrode mix are generally integrated into the mix as carbon fiber bundles (i.e., agglomerations) due to the very low dispersability of carbon fibers in pitch. Yet, one carbon fiber per unit volume of electrode material is as nearly effective for preventing crack formation as a bundle of carbon fibers per the same unit volume of electrode material. Therefore, the incorporation of agglomerated carbon fibers amounts to a highly inefficient and expensive method for toughening graphite electrodes. In addition, the clumping of carbon fibers typically results in large sections of unreinforced electrode material, and thus, an electrode more prone to failure than an electrode containing carbon fibers homogeneously dispersed throughout the electrode material.

Accordingly, there is a need in the art for graphite electrodes that are tougher by being less likely to fail during EAF operations. There is a particular need to improve existing methods for producing carbon fiber-reinforced graphite electrodes by more homogeneously dispersing the carbon fibers throughout the electrode material. Such a method would allow for smaller amounts of carbon fibers to be used, while advantageously lowering the cost of the electrode (and EAF process) and providing a graphite electrode of the same or greater overall toughness than current fiber-reinforced graphite electrodes.

### SUMMARY OF THE INVENTION

In one aspect, the present invention is directed to a method for producing a carbon fiber-containing pitch binder (i.e., “carbon fiber-pitch binder”), wherein the carbon fibers are substantially homogeneously dispersed throughout the pitch binder. The resulting material, in either solid, semi-solid, or liquid form, can be used as an improved source of carbon fiber-pitch binder for the manufacture of any desired graphitic article, e.g., a crucible or electrode.

In a preferred embodiment, the carbon fiber-pitch binder is produced by homogeneously integrating surface-modified carbon fibers into a molten pitch binder, wherein the surface-modified carbon fibers possess a surface that has been modified in a manner that increases the dispersability of the carbon fibers into the molten pitch binder.

In another aspect, the invention is directed to a method for producing a toughened graphite electrode by (i) combining the carbon fiber-pitch binder described above with a petroleum coke filler to produce a malleable binder-filler mix; (ii) shaping the malleable binder-filler mix into a shape of an electrode; and (iii) graphitizing the shaped binder-filler mix by subjecting the shaped binder-filler mix to a temperature and for a time effective for inducing graphitization of the shaped binder-filler mix.

In yet another aspect, the invention is directed to a method for processing a metal in an electric arc furnace by use of the toughened graphite electrode described above. In the method, the toughened graphite electrode is electrically connected to the metal to be processed, and an arcing voltage is applied to the toughened graphite electrode of a magnitude high enough to induce melting of the metal.

In still another aspect, the invention is directed to a pitch binder composition and pitch binder-filler mix (e.g., a graphite electrode composition) in which carbon fibers are substantially homogeneously dispersed therein by application of the inventive method. In particular, the graphite electrode composition possesses improved properties of for example, increased strength and reduced transverse and/or longitudinal coefficient of thermal expansion.

Thus, as will be described in further detail below, the method advantageously provides graphite electrodes that are tougher and less likely to fail during EAF operations. The method improves existing methods for carbon fiber-reinforcement of graphite electrodes by homogeneously dispersing the carbon fibers throughout the electrode material. The method, therefore, in particular, permits smaller amounts of carbon fibers to be used per volume of graphitized electrode material, while advantageously lowering the cost of the electrode (and EAF process) and providing a graphite electrode of the same or greater overall toughness (i.e., strength or durability) than current carbon fiber-reinforced graphite electrodes.

In addition, by virtue of the increased toughness of the electrode, virtually all types of metal scrap can be processed by the arc furnace (i.e., for melting and reclamation) without requiring a pre-sorting step. Therefore, the method also provides the benefit of decreasing the processing time between EAF runs and increasing the output of processed metal.

### BRIEF DESCRIPTION OF THE FIGURES

FIG. 1 Image showing as-received carbon fibers vs. heat-treated carbon fibers in pitch after carbon fiber-pitch mixture was allowed to cool and solidify (five comparative samples shown having a carbon fiber wt % of about 0.9% to about 6.3%).

FIG. 2 Image of a pitch-only sample (i.e., without added carbon fibers)

FIG. 3 Close-up image showing as-received carbon fibers vs. heat-treated carbon fibers in pitch after carbon fiber-pitch mixture was allowed to cool and solidify.

FIG. 4 Image showing solidified fiber-pitch mixtures containing higher weight percentages of fibers (three samples shown having a carbon fiber wt % of 7% to 9.5%).

### DETAILED DESCRIPTION OF THE INVENTION

In one aspect, the invention is directed to a method for producing a carbon fiber-pitch binder wherein the carbon fibers are substantially homogeneously dispersed throughout the pitch binder. By being “substantially homogeneously dispersed”, preferably at least 50%, 60%, 70%, 80%, 90%, 95%, 96%, 97%, or 98% of the carbon fibers are unbound to one or more other carbon fibers, preferably as monofilaments (i.e., not agglomerated or bundled).

As known in the art, the pitch binder can be any of the highly carbonaceous and viscous materials derived from either petroleum products or plants. Petroleum-derived pitch is also known as bitumen or coal-tar pitch. Pitch can typically attain a viscosity of about 0.1 to about 5 poise by heating the pitch to a temperature within the range of 140° C. to 260° C. under ordinary pressure (e.g., about 1 atm). The pitch binder may also contain up to about 18% natural Q.I. particles. The Q.I. particles refer to the percentage of particles in a given pitch which are insoluble in quinoline as determined by quinoline extraction at 75° C. In particular embodiments, the pitch may contain, for example, about 0%, or about or less than 1%, 2%, 5%, or 10% Q.I. solids, or any range resulting from any two of these values. The initial softening point (SP) of the pitch is typically in the range 80-125° C., and more typically in the range 95-110° C. The modified Conradson Carbon (MCC) value of the pitch is typically within the range of about 40-50%. The Cleveland Open Cup flash point (FP) of the pitch is typically in the range of about 240-300° C. Both the SP and FP values, in particular, are very much dependent on the degree of distillation of the pitch. In turn, the degree of distillation of the pitch has an effect on the overall amount and proportions of polyaromatic hydrocarbons residing in the crude pitch.

In the method, the pitch is made molten by heating the pitch to a suitable softening temperature as described above. Molten pitch refers to pitch that is flowable, and more particularly, flowable to the extent that homogeneous mixing or blending of a solid filler material therein is possible. The molten pitch preferably has a viscosity of no more than about 5,000 poise, more preferably no more than about 1,000 poise, more preferably no more than about 500 poise, and more preferably no more than about 100 poise. In particular preferred embodiments, the molten pitch has a viscosity of no more than 50, 25, 20, 10, 5, 2, or 1 poise. Typically, the molten pitch has a viscosity no less than 0.1, 0.2, 0.3, 0.4, or 0.5 poise. Any range of viscosity resulting from any two of the foregoing values is also contemplated herein.

The molten pitch is combined with the surface-modified carbon fibers in a manner that permits the carbon fibers to be evenly dispersed throughout the pitch. Any of the methods known in the art for homogeneously mixing a filler component into a viscous liquid can be used. For example, the carbon fiber-pitch mix can be mixed by hand, i.e., by use of a stirring bar, paddle, or spatula. The carbon fiber-pitch mix may also be stirred by a mechanical stirrer, or placed in a closed container and the container subjected to repetitive inversion or rotation. Preferably, the carbon fiber-pitch mix is stirred at a mixing rate that does not mill (i.e., reduce the size of, or triturate) the carbon fibers. More particularly, the carbon fiber-pitch mix is preferably stirred at a mixing rate of less than about 100 revolutions per minute (100 rpm) for a sufficient time (e.g., 10-120 minutes) such that the fibers are substantially dispersed throughout the pitch. For example, in different embodiments, the carbon fiber-pitch mix is preferably stirred at a mixing rate of or less than 80 rpm, 70 rpm, 60 rpm, 50 rpm, 40 rpm, 30 rpm, 20 rpm, 10 rpm, 5 rpm, or a range resulting from any two of the foregoing values.

Preferably, the surface-modified carbon fibers are present in the carbon fiber-pitch material in an amount of at least 1 wt % with respect to the total mass of the carbon fiber-pitch mix. More preferably, the surface-modified carbon fibers are present in an amount of at least 2, 3, 4, 5, 8, 10, 12, 15, 18, 20, or 22 wt %. The surface-modified carbon fibers may also be present within a range resulting from any two of the foregoing wt % values.

The carbon fibers used in the present invention may be derived from any suitable carbonaceous starting material, e.g., mesophase pitch, isotropic pitch) polyacrylonitrile (PAN), or rayon. Preferably, the carbon fibers have a tensile strength greater than about 100,000 psi, and more preferably, greater than about 300,000 psi.

The carbon fibers used in the invention may be of any suitable length and diameter, as long as the length is longer than the diameter. Preferably, the length of the carbon fiber is at least twice its width. More preferably, the length of the carbon fiber is at least five ten, twenty, fifty, one hundred, five hundred, or one thousand times its diameter. For example, in different embodiments, the carbon fibers (i.e., monofilaments) may have lengths of 1 μm, 10 μm, 20 μm, 50 μm, 100 μm, 500 μm, 1 mm, 5 mm, 10 mm, 20 mm, 30 mm, 40 mm, 50 mm, 60 mm, 70 mm, 80 mm, 90 mm, or 100 mm (or any range resulting from two of these values), and independently, diameters of, for example, 100 nm, 500 nm, 1 μm, 5 μm, 10 μm, 20 μm, 30 μm, 40 μm, 50 μm, 60 μm, 70 μm, 80 μm, 90 μm, or 100 μm (or any range resulting from two of these values), wherein the diameter value is selected to be less than the length value.

The carbon fiber being mixed into the molten pitch possesses a surface that has been modified such that the dispersability of the carbon fibers is increased in the molten pitch as compared to carbon fibers whose surface has not been modified. Without being bound by any theory, it is believed that the generally observed low dispersability of unmodified carbon fibers in molten pitch is due to the presence of polar or hydrophilic atoms or groups (e.g., oxides, hydroxides, amines, and the like) on the carbon fiber surface. Accordingly, any process by which the hydrophilic groups are removed (or modified by appropriate substitution or derivatization to render the surface non-polar or hydrophobic) is believed to be particularly applicable herein.

In one embodiment, carbon fibers are surface modified by being heated to a temperature above 25° C. in an inert atmosphere for a period of time such that the dispersability of the carbon fibers in molten pitch is increased. In different embodiments, the carbon fibers are preferably heated to a temperature at or above, for example, 30° C., 40° C., 50° C., 100° C., 200° C., 300° C., 400° C., 500° C., 600° C., 700° C., 800° C., 900° C., 1000° C., 1100° C., or 1200° C., or within a range resulting from any two of the foregoing temperatures. A heating temperature within the range of 800-900° C., or about 850° C., is particularly preferred. At a temperature of about 850° C., a heating time (i.e., residence time at this temperature) of about one hour is preferred. It is well known in the art that application of higher temperatures typically permits for shorter residence times to achieve the same result. For example, it may be possible to achieve the same increased level of dispersability of the carbon fibers by heating for about 0.5 hours at 1000° C., or about 1 hour at 850° C., or about 2 hours at 750° C., or about 3 hours at 650° C., or 5-6 hours at 500° C., or 24-48 hours at 100° C. The inert atmosphere is preferably established by replacement of air with an inert (i.e., non-reactive) gas, such as nitrogen or the noble gases (e.g., He, Ne, Ar, and Kr). Preferably, the inert atmosphere contains no more than about 0.5% v/v of oxygen or other reactive gas, and more preferably, no more than 0.1%, 0.05%, or 0.01% v/v of oxygen or other reactive gas. Without being bound by any theory, it is believed that the heating process increases the dispersability of the carbon fibers in pitch by removing hydrophilic chemical groups or atoms from the surface of the carbon fibers.

The heating process can be accompanied by any additional process steps that facilitate the surface modification process. For example, the heating process may be conducted in the presence of a reductive gaseous atmosphere (e.g., hydrogen or ammonia). In addition, the heating temperature and residence time can be appropriately modified such that reduction of the surface (i.e., primarily to carbon-hydrogen and carbon-carbon bonds) by a reductive gas is effected.

In another embodiment, carbon fibers are rendered dispersible in molten pitch by surface treatment with a chemical (i.e., a molecular or polymeric agent) that causes the carbon fiber surface to be substantially hydrophobic. In one embodiment, a hydrophobic agent coats the surface of the carbon fibers. Some examples of such agents include hydrophobic polymers, such as polyethylene, polypropylene, graphite, conjugated conductive polymers, and the like. In another embodiment, the agent functions by removing hydrophilic groups from the carbon fiber surface. In yet another embodiment, the agent replaces the hydrophilic groups with hydrophobic groups, or modifies (i.e., derivatizes) the hydrophilic groups such that they are converted to hydrophobic groups (e.g., by reaction with a hydrophobic diazonium salt or a strong reducing agent under appropriate conditions).

The resulting carbon fiber-pitch mix, in the absence of a solid filler material (i.e., by itself), can be cooled to solidification without the addition of a solid filler material. The solidified carbon fiber-pitch material is advantageously transportable and hence, a convenient source of homogeneously dispersed carbon fibers for any end application that can make use of a pitch binder and carbon fibers. The solidified carbon fiber-pitch material can be used in the manufacture of, for example, graphite electrode, crucibles, and refractory tools and equipment. The solidified carbon fiber-pitch mix preferably has a SP value of at least about 90° C., 100° C., 120° C., 140° C., 160° C., or 180° C., and up to about 200° C., a MCC value of at least 50%, 55%, 60%, 65%, or 70%, and up to about 75%, and a viscosity of about 1 to about 50 poise in the temperature range of 140-180° C.

When a solid filler material is desired to be included, the carbon fiber-pitch mix can be maintained in a molten state while a filler is admixed therein. The resulting binder-filler mix, along with any additional suitable materials, is then typically shaped into a desired article (e.g., electrode) and solidified by cooling. As used herein, the “filler material” (i.e., “filler”) can be any of the solid powderized or granulated materials known in the art, excluding the carbon fibers described above, that are useful for modifying the physical and/or behavioral properties of a matrix material. Some examples of fillers include calcium carbonate, metal oxides (e.g., the transition metal oxides), main group oxides (e.g., silicon oxide or aluminum oxide), metal and main group hydroxides (e.g., aluminum hydroxide), metal and main group silicates (e.g., calcium silicate), and carbon-based materials (e.g., graphite, coke, or petroleum coke). The filler material can function to, for example, increase the strength or temperature resistance of the material, or decrease the coefficient of thermal expansion. The filler material may also function to increase the hardness, decrease the brittleness, or decrease susceptibility of the material to cracking or fissuring. The filler material can be included in any suitable amount, e.g., 1, 2, 3, 4, 5, 8, 10, 15, 20, 25, 30, or 35 wt %.

In another aspect, the invention is directed to a method for producing a toughened graphite electrode. In the method, molten carbon fiber-pitch material is first combined (as described above) with a petroleum coke filler to produce a binder-filler mix. The petroleum coke filler (hereinafter also referred to as “coke”) is typically in the form of particles or chunks of any suitable size (e.g., 1-25 mm). As known in the art, petroleum coke is a carbonaceous solid typically obtained as a byproduct from oil refinery coker units. The coke can be of any suitable grade or derivative, e.g., marketable coke (of high carbon content and useful as a fuel), needle coke (a highly crystalline form of coke), catalyst (impure) coke, green coke (raw coke), calcined coke, or anode grade coke. Typically, the coke filler is included in an amount of at least about 5, 8, 10, 15, 20, 25, 30, or 35 wt % with respect to the total weight of the binder-filler mix.

The coke is blended into the carbon fiber-pitch material by any suitable method known in the art, as described above, while the carbon fiber-pitch material is in a flowable (i.e., molten) state. After the coke is blended into the carbon fiber-pitch material, the resulting binder-filler mix is maintained in a malleable (i.e., shapable) state at least for the period of time until the binder-filler mix has been finally shaped. Depending on the compositional details of the binder-filler mix, the binder-filler mix can typically be maintained in a malleable state by maintaining its temperature at, for example, 160° C., 170° C., 180° C., 190° C., or 200° C., or a temperature range between any two of these values. The binder-filler mix is malleable by having a sufficiently soft form that permits the binder-filler mix to be extruded through a die or transferred into a mold. Hence, as used herein, the term “malleable” also includes “extrudable” or “moldable”.

The binder-filler mix can be shaped by any suitable method known in the art. In one embodiment, the binder-filler mix is extruded through a die into a final desired shape. In another embodiment, the binder-filler mix is molded into a desired shape by its transfer into a mold. The binder-filler mix can be shaped into any suitable shape and size for a graphite electrode. Typically, the shape of the electrode is cylindrical while the size can vary from, for example, 1 cm to several meters in length and 1 mm to 100 cm in thickness.

After the binder-filler mix is suitably shaped, the shaped material is then graphitized. The conditions required for graphitizing various materials, and in particular, pitch-coke blends, are well known in the art. Depending on the particular characteristics of the pitch-coke blend, the graphitization temperature can suitably be selected to be, for example, at least 2500° C., 2600° C., 2700° C., 2800° C., 2900° C., 3000° C., 3100° C., 3200° C., or 3300° C., or a range resulting from any two of the foregoing temperatures. The period of time at which the material is held at the graphitization temperature is typically within the range of about 1.5-4 hours.

As known in the art, the graphitizing step is often preceded by a carbonizing step. The purpose of the carbonization process is to heat the pitch to a temperature at which it carbonizes (typically at least 1000° C. and up to 2000° C.), after which the pitch is set and cannot be melted or re-liquefied. Typically, the carbonization temperature is maintained for at least 24 hours and no more than 1 week. The carbonization step is typically performed in an autoclave unit wherein the electrodes to be carbonized are placed in a container packed with sand, i.e., a “sagger can”. The sagger can and packed sand are present in order to keep the electrode from sagging (i.e., “slumping”) during carbonization. The electrode will sag or slump because the pitch binder is a thermoplastic material, and thus, has a period of fluidity during the heat treatment of the carbonization step. The addition of fibers to the pitch in the electrode may lessen sagging during carbonization.

The graphite electrode thus produced preferably possesses a reduced coefficient of thermal expansion and increased strength (i.e., the electrode's ability to avoid breaking during use in the arc furnace) as compared to graphite electrodes of the art in which the carbon fibers are not homogeneously dispersed. Preferably, the graphite electrode produced according to the invention possesses a longitudinal coefficient of thermal expansion (longitudinal CTE) of or less than −0.5×10⁻⁶/° C., −0.25×10⁻⁶/° C., −0.1×10⁻⁶/° C., −0.05×10⁻⁶/° C., 0.05×10⁻⁶/° C., 0.1×10⁻⁶/° C., or 0.15×10⁻⁶/° C., or any suitable range between two of the foregoing values. In different embodiments, the surface-modified carbon fibers are preferably present in the graphite electrode in an amount of at least 1, 2, 3, 4, 5, 8, 10, 12, 15, 18, 20, 22 wt %, or any range resulting from any two of these values.

In another aspect, the invention is directed to a method for processing a metal in an electric arc furnace (EAF) by use of the toughened graphite electrode described above. The purpose of EAF treatment of a metal is generally to melt the metal by means of an electric arc. The process is used on a large scale for the reclamation of metal scrap. Though numerous metals and their alloys can be treated by an EAF process, the most common types of metals treated by an EAF process are the iron-containing or titanium-containing metals or alloys. Of particular note are the various steels, which are among the most common of the metals processed by EAF methods.

As known in the art, EAF processing of metals involves, minimally, electrically connecting the graphite electrode to the metal pieces to be processed, and applying an arcing voltage to the graphite electrode of a magnitude high enough to induce melting of the metal. Though there are a wide range of sizes of EAF units, each having different electrical requirements or capacities, most EAF units typically employ a secondary voltage (i.e., the voltage that initiates and continues the melting process) of about 400-900 volts and a secondary current of about 34,000-44,000 amps. The EAF typically includes a refractory-lined vessel. The EAF may include oxygen fuel burners to add to the heat energy or make the heating more uniform. Additional heat energy can be generated by, for example, injecting reactive chemicals (e.g., oxygen and/or carbon) into the furnace. In addition, metal scrap may be pre-heated (preferably by hot furnace exhaust gases) before being processed in the EAF.

Examples have been set forth below for the purpose of illustration and to describe certain specific embodiments of the invention. However, the scope of this invention is not to be in any way limited by the examples set forth herein.

### EXAMPLE 1

### Preparation of Untreated Carbon Fibers/Pitch Samples

The dispersability of untreated carbon fibers in molten pitch was determined by mixing carbon fiber bundles, as-received without any surface treatment, into five samples of molten pitch as follows. First, five samples of coal-tar pitch were taken above their softening point and thereby made molten. Thereafter, a bundle of as-received fibers was added to each sample of molten pitch. The fiber-pitch mixture was stirred using a stainless steel spatula. Table 1 below lists the quantities of carbon fibers and pitch that were used for each of the five samples. The samples were made to vary in wt % of carbon fibers from 0.9 wt % to 6.3 wt % (for test nos. 1-5, respectively). The samples were then cooled to the solidification point of the pitch binder, after which the samples were analyzed.

TABLE 1
Fiber and pitch quantities used for as-received fibers

| Test Number | Quantity of Fibers (g) | Quantity of pitch (g) |
|---|---|---|
| 1 | 0.118 | 13.196 |
| 2 | 0.307 | 13.564 |
| 3 | 0.507 | 13.290 |
| 4 | 0.710 | 13.202 |
| 5 | 0.909 | 13.447 |

### EXAMPLE 2

### Heat Treatment of Carbon Fibers

Carbon fiber bundles were heat-treated by being heated to about 850° C. under flowing nitrogen and maintained at this temperature for one hour. The carbon fibers, thus treated, were cooled to below 200° C., after which point they could optionally be exposed to air without a detrimental effect. If exposed to air after the heat treatment, the carbon fibers were preferably used (e.g., combined with pitch) within two hours, and preferably less than one hour, after completion of the heat treatment. If maintained under a substantially inert atmosphere after the heat treatment, the carbon fibers may be stored in this manner until use.

### EXAMPLE 3

### Preparation of Heat-Treated Carbon Fibers/Pitch Samples

Heat-treated carbon fibers, prepared as described in Example 2, were then mixed into five pitch samples, and the resulting fiber-pitch mixtures solidified in a completely analogous manner as described above for the as-received carbon fibers in Example 1. Table 2 below lists the quantities of heat-treated carbon fibers and pitch that were used for the five samples. The five samples containing the heat-treated carbon fibers vary similarly in carbon fiber wt % to the five samples containing as-received carbon fibers. The five samples containing heat-treated carbon fibers were then solidified by cooling, and then analyzed, as described above for the as-received samples.

TABLE 2
Fiber and pitch quantities used for heat-treated fibers

| Test Number | Quantity of Fibers (g) | Quantity of pitch (g) |
|---|---|---|
| 1 | 0.100 | 13.203 |
| 2 | 0.303 | 13.243 |
| 3 | 0.504 | 13.261 |
| 4 | 0.708 | 13.426 |
| 5 | 0.903 | 13.233 |

### EXAMPLE 4

### Comparison of Dispersability of Untreated and Heat-Treated Carbon Fibers

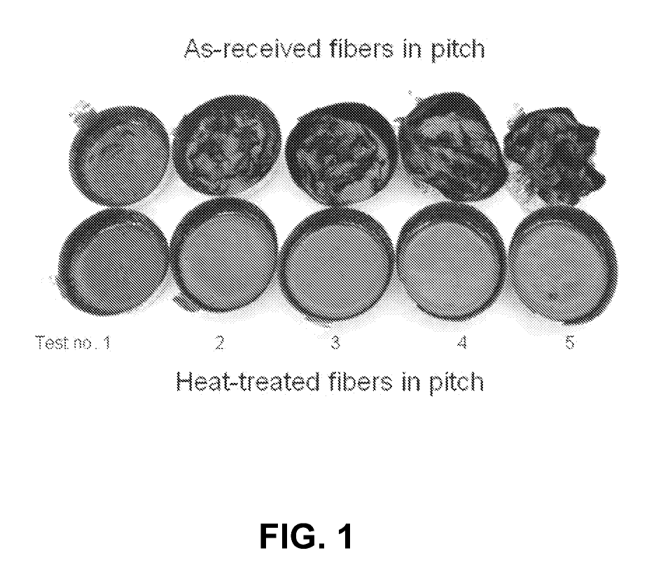

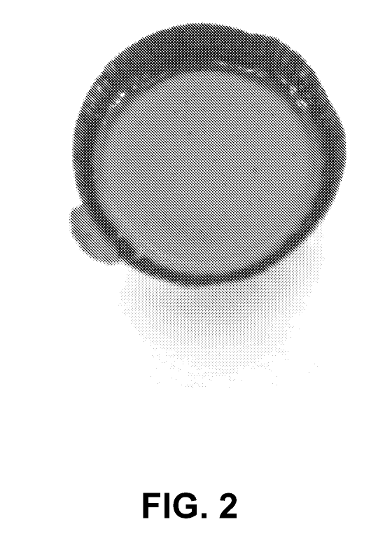

FIG. 1 shows comparative images of the pitch samples containing the as-received carbon fibers and pitch samples containing the heat-treated carbon fiber. For further comparison, a sample of pitch without carbon fibers (i.e., a pitch-only sample) was heated to above its softening point, stirred vigorously, and then allowed to cool. FIG. 2 shows an image of the pitch-only sample prepared in this manner.

As shown by FIG. 1, pitch samples containing heat-treated carbon fibers (bottom samples) appear significantly lighter (i.e., brighter or more reflective, as opposed to darker or duller) than the pitch samples containing as-received carbon fibers (top samples) for each of the five weight percentages of carbon fibers. Surprisingly, the heat-treated carbon fiber/pitch samples appeared visually much the same as the pitch-only sample. The increased brightness of the heat-treated carbon fiber/pitch samples is a result of the significantly improved dispersability of the heat-treated fibers as compared to the as-received fibers.

In particular, it is observed that carbon fibers in the as-received carbon fiber/pitch samples are present as large agglomerations. The agglomerations render significant portions of the sample blackened in color and substantially reduced in brightness as compared to the heat-treated carbon fiber/pitch samples. For the as-received carbon fiber/pitch samples, even the lowest quantity tested (0.118 g) was very poorly dispersed in the pitch; and the highest quantity used (i.e., the no. 5 test, 0.909 g) was essentially completely undispersed and in the form of an agglomerated mass. In contrast, all of the five heat-treated carbon fibers/pitch samples show a substantial absence of carbon fiber agglomerations, even for the highest carbon fiber wt % sample (no. 5).

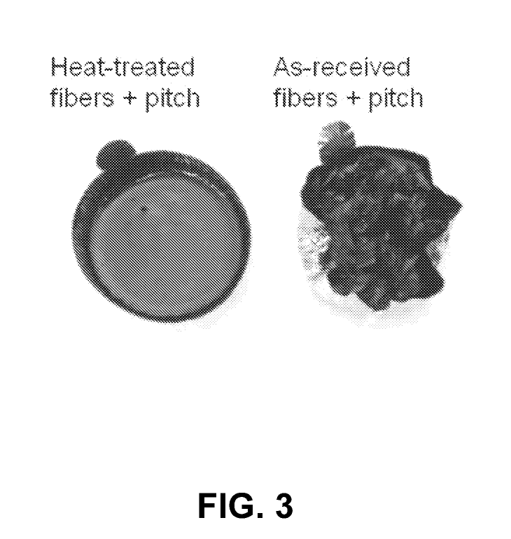

Another set of samples of pitch containing as-received and heat-treated carbon fibers to pitch was prepared, as described above, using 0.823 g of fibers and 13.21 g of pitch. As shown by FIG. 3, the as-received fibers dispersed poorly (if at all) in the pitch while the heat-treated carbon fibers were dispersed in a substantially homogenous manner throughout the pitch such that the sample possessed a much higher brightness.

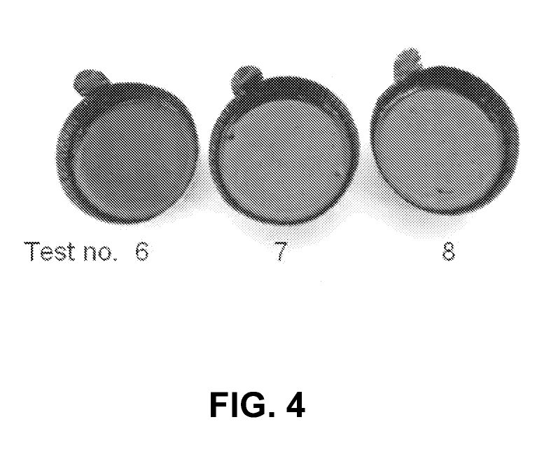

Additional experiments were conducted to ascertain if heat-treated carbon fiber/pitch samples could maintain a substantial dispersion of carbon fibers in pitch samples containing carbon fiber weight percents well above 6 wt % (i.e., above the highest carbon fiber wt % used in the above examples). Table 3 shows the masses of heat-treated carbon fibers used in three samples varying from about 7 wt % to 9.5 wt % of carbon fiber. FIG. 4 shows the surprising result that even with the increased weight percentage of carbon fibers, the carbon fibers remained substantially homogenously dispersed in the pitch such that the brightness of the samples were similar to the brightness of the pitch-only sample.

TABLE 3
Fiber and pitch quantities used for heat-treated fibers
(continued)

| Test Number | Quantity of Fibers (g) | Quantity of pitch (g) |
|---|---|---|
| 6 | 1.012 | 13.367 |
| 7 | 1.209 | 13.201 |
| 8 | 1.400 | 13.307 |

While there have been shown and described what are at present considered the preferred embodiments of the invention, those skilled in the art may make various changes and modifications which remain within the scope of the invention defined by the appended claims.

What is claimed is:

1. A method for producing a carbon fiber-containing pitch binder, the method comprising combining surface-modified carbon fibers with a molten pitch binder such that the surface-modified carbon fibers are substantially homogeneously dispersed throughout said molten pitch binder, wherein said surface-modified carbon fibers possess a surface that has been modified in a manner that increases the dispersability of the carbon fibers into said molten pitch binder.

2. The method of claim 1, wherein said pitch is coal-tar pitch.

3. The method of claim 1, wherein said molten pitch binder possesses a viscosity at or less than 100 poise.

4. The method of claim 1, wherein said molten pitch binder possesses a viscosity at or less than 10 poise.

5. The method of claim 1, further comprising cooling the carbon fiber-containing pitch binder to form a solid carbon fiber-containing pitch material.

6. The method of claim 1, further comprising admixing a filler into said carbon fiber-containing pitch binder to form a binder-filler mix.

7. The method of claim 6, wherein said binder-filler mix is solidified to form a binder-filler composite solid.

8. The method of claim 6, wherein said filler is a petroleum coke filler.

9. The method of claim 1, wherein said surface-modified carbon fibers are prepared by heating carbon fibers under an inert atmosphere at a temperature above 25° C. for a period of time such that the dispersability of the carbon fibers in molten pitch is increased.

10. The method of claim 9, wherein said temperature is at or above 100° C.

11. The method of claim 9, wherein said temperature is at or above 300° C.

12. The method of claim 9, wherein said temperature is at or above 500° C.

13. The method of claim 9, wherein said temperature is at or above 1000° C.

14. The method of claim 1, wherein said surface-modified carbon fibers are prepared by treating carbon fibers with an agent that increases the dispersability of said carbon fibers in molten pitch.

15. The method of claim 1, wherein the surface-modified carbon fibers are substantially homogeneously dispersed throughout said pitch binder in that at least 80% of the number of carbon fibers are unbound to one or more other carbon fibers.

16. The method of claim 1, wherein the surface-modified carbon fibers are substantially homogeneously dispersed throughout said pitch binder in that at least 90% of the number of carbon fibers are unbound to one or more other carbon fibers.

17. The method of claim 1, wherein said surface-modified carbon fibers are present in said carbon fiber-containing pitch in an amount of at least 5 wt % with respect to the total mass of the carbon fiber-containing pitch.

18. The method of claim 1, wherein said surface-modified carbon fibers are present in said carbon fiber-containing pitch in an amount of at least 10 wt % with respect to the total mass of the carbon fiber-containing pitch.

19. The method of claim 1, wherein the surface-modified carbon fibers are combined with the molten pitch binder by mixing the surface-modified carbon fibers with the molten pitch binder at a mixing rate at or less than 80 rpm.

20. The method of claim 1, wherein a carbonization step conducted at a temperature of at least 1000° C. and up to 2000° C. precedes the graphitization step.

21. A method for producing a toughened graphite electrode, the method comprising:
(i) combining the carbon fiber-containing pitch binder of claim 1 with a petroleum coke filler to produce a malleable binder-filler mix;
(ii) shaping the malleable binder-filler mix into a shape of an electrode; and
(iii) graphitizing the shaped binder-filler mix by subjecting the shaped binder-filler mix to a temperature of at least about 2500° C. for a time effective for inducing graphitization of the shaped binder-filler mix.

22. The method of claim 21, wherein said pitch is coal-tar pitch.

23. The method of claim 21, wherein the surface-modified carbon fibers are substantially homogeneously dispersed throughout said binder-filler mix in that at least 80% of the number of carbon fibers are unbound to one or more other carbon fibers.

24. The method of claim 21, wherein the surface-modified carbon fibers are substantially homogeneously dispersed throughout said binder-filler mix in that at least 90% of the number of carbon fibers are unbound to one or more other carbon fibers.

25. The method of claim 21, wherein said surface-modified carbon fibers are present in said binder-filler mix in an amount of at least 5 wt % with respect to the total mass of said binder-filler mix.

26. The method of claim 21, wherein said surface-modified carbon fibers are present in said binder-filler mix in an amount of at least 10 wt % with respect to the total mass of said binder-filler mix.

27. The method of claim 21, wherein a carbonization step conducted at a temperature of at least 1000° C. and up to 2000° C. precedes the graphitization step.

28. A method for processing a metal in an electric arc furnace, the method comprising:
(i) providing a toughened graphite electrode produced according to claim 21;
(ii) electrically connecting the toughened graphite electrode to the metal to be processed; and
(iii) applying an arcing voltage to said toughened graphite electrode of a magnitude high enough to induce melting of the metal.

29. The method according to claim 28, wherein said metal comprises an iron- or titanium-containing metal or metal alloy.

30. The method according to claim 28, wherein said metal is a steel.

31. A carbon fiber-containing pitch binder composition comprising: (i) a pitch binder component and (ii) a carbon fiber component substantially homogeneously dispersed in the pitch binder component such that at least 80% of the number of carbon fibers are unbound to one or more other carbon fibers.

32. The pitch binder composition of claim 31, wherein at least 90% of the number of carbon fibers are unbound to one or more other carbon fibers.

33. The pitch binder composition of claim 31, wherein the carbon fibers are present in an amount of more than 10 wt % with respect to the total mass of the carbon fiber-containing pitch composition.

34. The pitch binder composition of claim 31, wherein the carbon fibers are present in an amount of or greater than 12 wt % with respect to the total mass of the carbon fiber-containing pitch composition.

35. The pitch binder composition of claim 31, wherein the carbon fibers are present in an amount of or greater than 15 wt %/o with respect to the total mass of the carbon fiber-containing pitch composition.

36. A pitch binder-filler composition comprising (i) a pitch binder component, (ii) a carbon fiber component substantially homogeneously dispersed in the pitch binder component such that at least 80% of the number of carbon fibers are unbound to one or more other carbon fibers, and (iii) a filler component.

37. The pitch binder-filler composition of claim 36, wherein said filler component is a petroleum coke filler.

38. The pitch binder-filler composition of claim 36, wherein said filler component is present in an amount of at least about 10 wt % with respect to the total mass of the pitch binder-filler composition.

39. The pitch binder-filler composition of claim 36, wherein at least 90% of the number of carbon fibers are unbound to one or more other carbon fibers.

40. The pitch binder-filler composition of claim 36, wherein the carbon fibers are present in an amount of more than 10 wt % with respect to the total mass of the pitch binder-iller composition.

41. The pitch binder-filler composition of claim 36, wherein the carbon fibers are present in an amount of or greater than 12 wt % with respect to the total mass of the pitch binder-filler composition.

42. The pitch binder composition of claim 36, wherein the carbon fibers are present in an amount of or greater than 15 wt % with respect to the total mass of the pitch binder-filler composition.
